(19) United States
(12) Patent Application Publication
(10) Pub. No.: US 2012/0105861 A1
(43) Pub. Date: May 3, 2012

(54) DEVICE AND METHOD FOR DETERMINING OPTICAL PATH LENGTHS

(76) Inventor: Thilo Weitzel, Herrenschwanden (CH)

(21) Appl. No.: 13/145,391

(22) PCT Filed: Jan. 20, 2009
(86) PCT No.: PCT/EP2009/000327

§ 371 Date: Sep. 28, 2011

(51) Int. Cl. G01B 9/02; G01B 11/02

(52) U.S. Cl. 356/479; 356/498

(57) ABSTRACT

The present invention relates to a method for determining optical path length differences and for optical coherence tomography, having the steps of: generating spatially coherent light by a light source (SQ, BQ) emitting a spatial monomode, or the emission thereof being limited to a single spatial mode by suitable means (F); dividing at least a part of the light coming from said light source into two spatially separated paths; placing a sample (P) to be measured in the measurement path; using as at least two detectors (D) or one detector (D, A) having at least two detector elements (D) and further means (S, T, BP, F, Q, L, G, Z) for guiding beams, said means bringing light from a reference path and a measurement path together to the detectors/detector elements (D) and bringing said light to interference; receiving and analyzing the light intensities at the detectors/detector elements (D) in order to obtain a data set; and numerically analyzing and displaying the data set such that conclusions are possible about both the spatial position and the strength of the reflection or scattering of the sample (P) or structures within the sample (P).

The invention relates to devices and methods for measuring optical path lengths suitable for the optical measurement of film thickness and optical coherence tomography.

Interferometric devices and methods using light with short coherence length (low coherence), sometimes referred to as white light interferometry, allow a precise determination of optical path lengths. Used in reflection such devices are able to determine distances and thus scan surfaces, for example in order to determine surface profiles. In suitable samples also structures inside the sample are measurable, which leads to optical coherence tomography.

The arrangements are characterized by an interferometric setup with two light paths which are hereinafter referred to as measurement arm and reference arm according to a description as a Michelson interferometer or with respect to other interferometric arrangements more generally as measuring path and reference path.

The known arrangements and methods can be divided into two groups:

Arrangements which vary the optical path length of the reference arm, for example by using a movable mirror, and use a single detector, produce an interference signal in dependence of the optical path length of the reference arm or—more precise—in dependence of the difference of the optical path lengths of the reference arm and the measurement arm. This signal shows a characteristic modulation if the difference in optical path lengths of measurement and the reference is smaller than the coherence length. These procedures are refered to as “optical coherence-domain reflectometry” (OCDR).

Arrangements with a fixed reference arm, which use an optical spectrometer as a detector to measure the spectrum of the interference signal. The spectrum shows a characteristic wavelength-dependent modulation as a function of the difference in optical path lengths in the measurement and reference arm. By using a numerical Fourier transform of the spectrum, the difference in path length can be determined. These methods are referred to as “optical Fourier-domain reflectometry,” or “spectral interferometry”.

In 1991 it was shown (Huang, “Optical coherence tomography,” Science 254, 11,781,181, 1991) that by OCDR it is possible to measure depth profiles of biological samples as far as the light can penetrate into a sample. By scanning in combination with computer-based numerical methods, a three-dimensional reconstruction and visualization of the sample is possible (OCT).

With better availability of suitable light sources and driven by medical applications the optical coherence tomography (OCT) has in recent years gone through a rapid technological evolution, which allowed the commercialization of the process.

Despite many technical advances, the arrangements are still based on one of the two mentioned methods. The term OCT usually designates devices based on optical coherence-domain reflectometry (OCDR), whereas for devices based on optical Fourier-domain reflectometry commonly the terms spectral-OCT (SOCT) or Fourierdoman-OCT (FDOCT) are used.

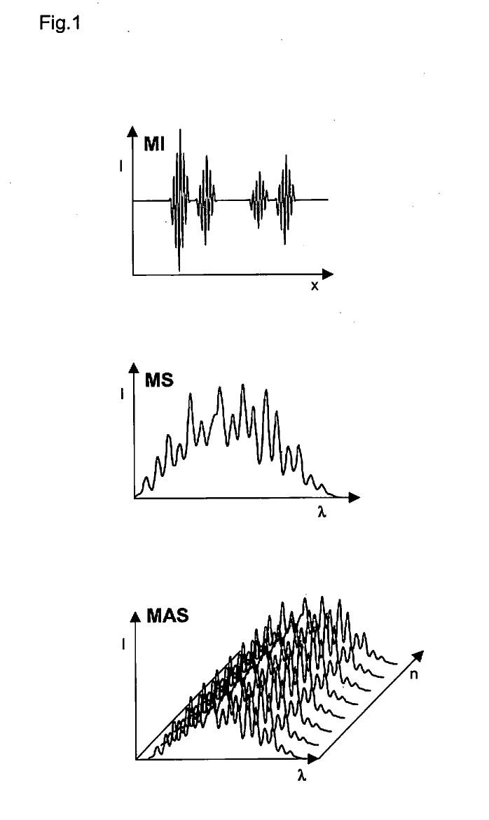

FIG. 1 first shows schematically the different measurement signals, produced by arrangements according to the prior art.

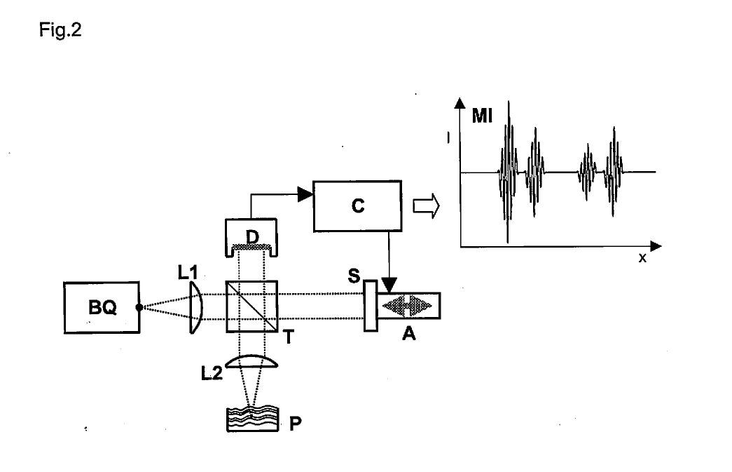

FIGS. 2 to 8 show variations of OCDR and FDOCT devices according to the state of the art. All such arrangements have in common that the light of a suitable spatially single-mode light source (BQ or SQ) is first split into a reference arm and a measurement arm, that the light reflected back from the arms is superimposed, and then that the resulting interference signal is guided again as a spatial single-mode to a detector (D) or spectrometer (SA). The measurement of intensity is carried out either as a function of varying optical path length in one of the arms or as a function of the wavelength.

FIG. 1, top, shows an example of an interferogram (MI) as it in principle can be measured by an arrangement according to “optical coherence-domain reflectometry” (OCDR). The abscissa (x) represents the variable difference of the optical path lengths as set by the interferometric setup, the ordinate (I) the intensity of the measured signal.

The bursts of fast modulation shown in the drawing each represent reflections from inside the sample and thus allow conclusions about the internal structure of the sample.

FIG. 1, center, shows an example of spectrogram (MS), as it in principle can be measured by an arrangement according to “optical Fourier-domain reflectometry” or “spectral OCT” (SOCT). The abscissa (λ) represents the wavelength, the ordinate (I) the intensity of the signal measured at each wavelength.

The modulation of the signal as shown in the drawing represents a superposition of different modulations, each characteristic for a respective difference in optical path lengths. The respective proportions of these modulations can be separated by numerical Fourier transformation of the measurements each representing a reflections from the interior of the sample and thus allowing conclusions about the internal structure of the sample.

FIG. 1, bottom, shows an example of a series of spectrograms (MAS) as they can be measured by an arrangement according to the “optical Fourier-domain reflectometry” or “spectral OCT” (SOCT) by using an imaging spectrometer. Each individual signal is an spectrogram and corresponds to an analogous spectrogram (MS) as shown in FIG. 1, center.

The abscissa (λ) represents the wavelength, the ordinate (I) the intensity of the signal measured at each wavelength. The additional coordinate (n) is a serial number for each individual measurement.

Using for example an imaging spectrometer an arrangement for “spectral OCT” is able to simultaneously detect signals from several points on the sample surface, roughly along a line. This accordingly allows for faster scanning of the sample, if it is to be studied in more than one place.

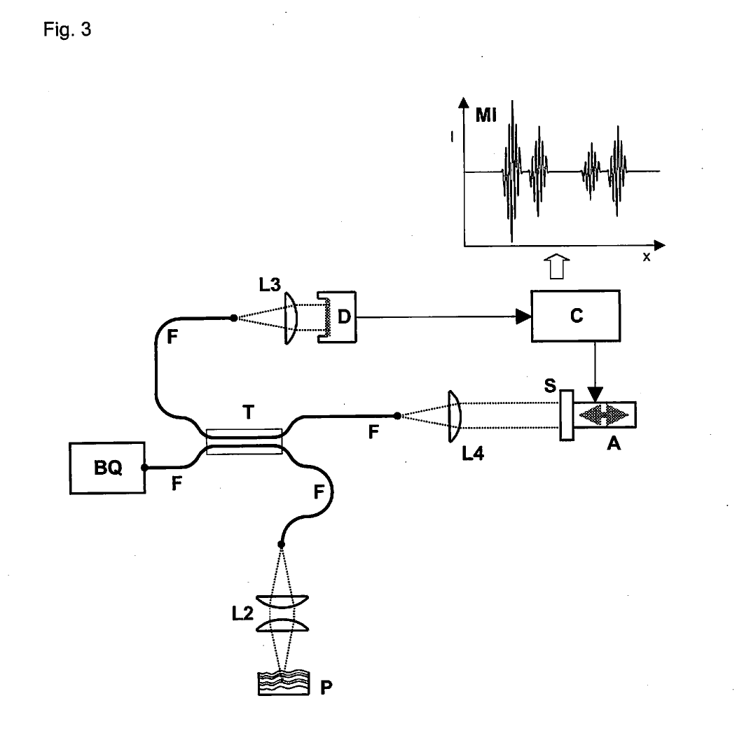

FIGS. 2 and 3 illustrate devices based on optical coherence-domain reflectometry:

FIG. 2 shows the classical arrangement based on a Michelson interferometer,

FIG. 3 shows a typical arrangement using optical fibers.

Both devices use a spectrally broadband light source (BQ) and a single detector (D).

A basic arrangement according to FIG. 2 uses a lens (LI) to first collimate the light from said light source (BQ). The resulting light beam is split by a beam splitter (T) with one part directed into the reference arm to a mirror (S), and the other part into the measurement arm with a focusing lens (L2) onto the sample.

Light from both arms is reflected back to the beam splitter (T), is superimposed and at the detector generates an interference signal depending on differences in path length. Commonly used additional apertures and spatial filters are not shown in the drawing.

In an arrangement according to FIG. 3, the light is guided using optical fibers (F). The light from said source (BQ) first reaches a fiber-optical beam splitter (T), which splits the light into the reference arm and via a collimating lens (L4) to a mirror (S), as well as into the measurement arm and via a focusing lens (L2) onto the sample. The light reflected back by the mirror (S) in one arm and the sample (P) in the other arm is through the said lens (L4) and the said focusing lens (L2) respectively directed back into the fibers, superimposed by the beam splitter (T) and finally through a collimating lens (L3) guided to said single detector (D), which records the interference signal depending on differences in path lengths.

Arrangements as shown in FIG. 2 or 3 employ electronic control and measuring devices (C), which control an actuator (A) that changes the optical path length in the reference arm and for each path length register the intensity measured at the detector, such that an resulting interferogram (MI) shows the intensity at the detector as a function of the difference in path lengths.

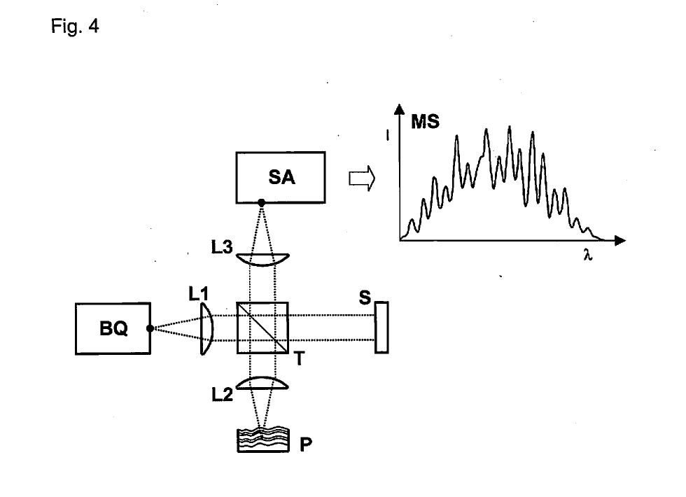

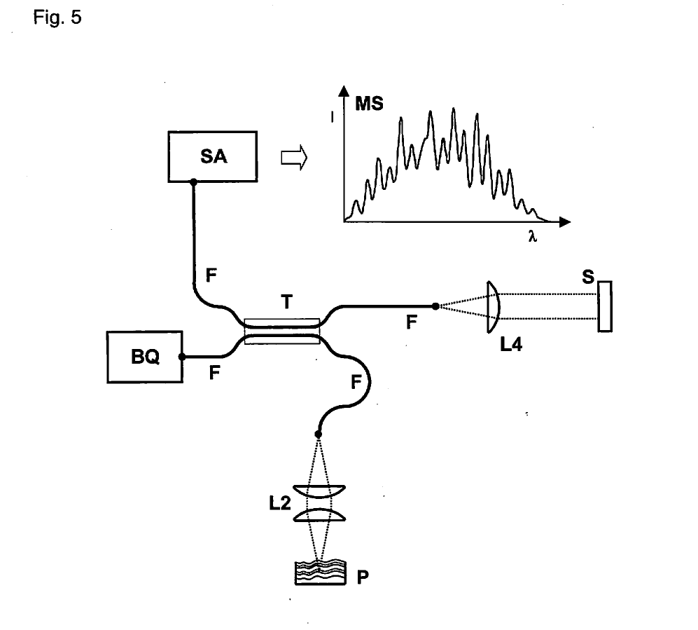

FIGS. 4 and 5 illustrate optical devices based on optical fourier-domain reflectometry (FD-OCT) or spectral OCT (SOCT): FIG. 4 shows the classical arrangement based on a Michelson interferometer, FIG. 5 shows the typical arrangement using optical fibers.

Both arrangements use a spectrally broadband light source (BQ) and an optical spectrometer (SA) as detector.

A basic arrangement as shown in FIG. 4 uses a lens (L1) to first collimate the light from said light source (BQ) to. The resulting light beam is split by a beam splitter (T) with one part directed into the reference arm to a mirror (S), and the other part into the measurement arm with a focusing lens (L2) onto the sample. Light from both arms is reflected back to the. beam splitter (T), is superimposed and by suitable optical elements (L3) collected into the above-mentioned spectrometer (SA). Commonly used additional apertures and spatial filters are not shown in the drawing.

In an arrangement according to FIG. 5, the light is guided using optical fibers (F). The light from said source (BQ) first reaches a fiber-optical beam splitter (T), which splits the light into the reference arm and via a collimating lens (L4) to a mirror (S), as well as into the measurement arm and via a focusing lens (L2) onto the sample. The light reflected back by the mirror (S) in one arm and the sample (P) in the other arm is through the said lens (L4) and the said focusing lens (L2) respectively directed back into the fibers, superimposed by the beam splitter (T) and finally guided to said spectrometer (SA) by another fibre (F).

The spectrometer in arrangements according to FIG. 4 or 5, then records a spectrogram (MS), which represents structures of the sample as described.

Instead of the broadband light source in combination with the spectrometer it is of course possible to use a fast spectral scanning light source (swept source) (SS-FD-OCT). With the availability of fast scanning monochromatic tunable laser, this variant is gaining increasing importance.

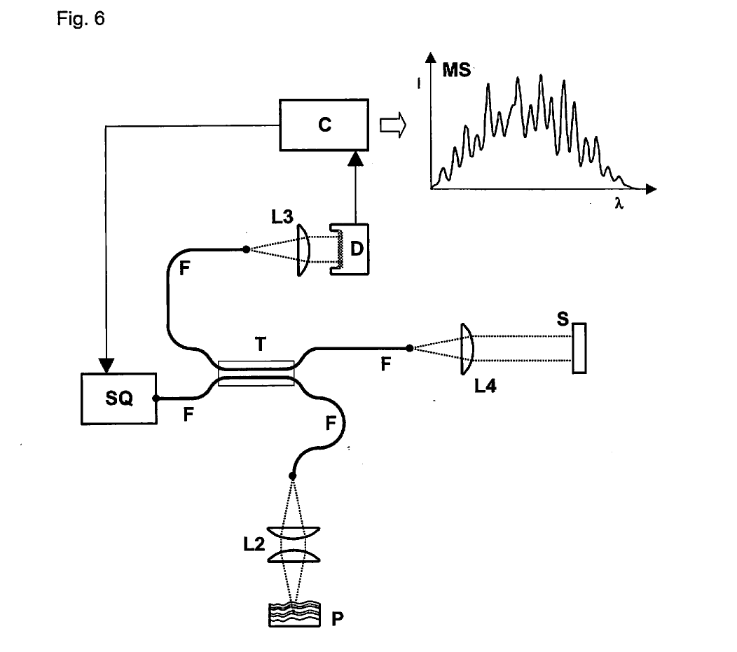

FIG. 6 shows the typical layout using a swept source. The resulting measurement is a spectrogram (MS) with the intensity measured as a function of wavelength.

In an arrangement according to FIG. 6, the light from said spectrally variable source (SQ) is guided using optical fibers (F) to a fiber-optical beam splitter (T), which splits the light into the reference arm and via a collimating lens (L4) to a mirror (S), as well as into the measurement arm and via a focusing lens (L2) onto the sample.

The light reflected back by the mirror (S) in one arm and the sample (P) in the other arm is through the said lens (L4) and the said focusing lens (L2) respectively directed back into the fibers, superimposed by the beam splitter (T) and finally through a collimating lens (L3) guided to said single detector (D), which records the interference signal depending on the wavelength.

The arrangement employs electronic control and measuring devices (C), which controls the light source (SQ) and for each wavelength registers the intensity measured at the detector, such that an resulting spectrogram (MS) shows the intensity at the detector as a function of the wavelength.

A range of differing embodiments of the setups shown can increase the efficiency of these arrangements or reduce the technical effort.

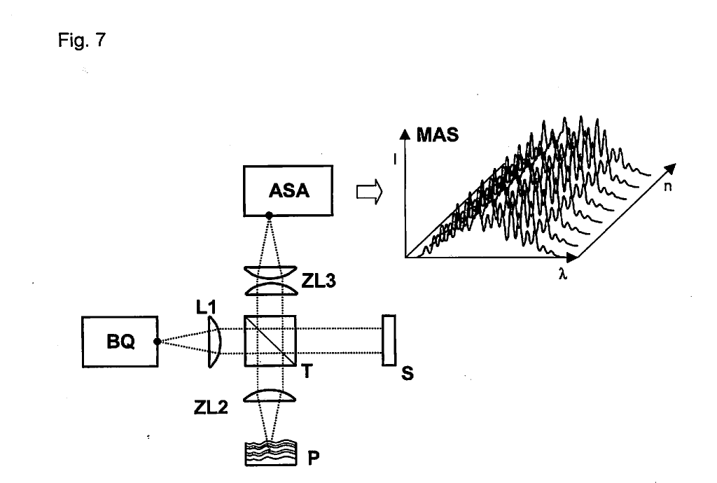

FIG. 7 shows an example of an OCT optical arrangement based on the optical fourier-domain reflectometr using an imaging spectrometer. Here the source initially is imaged onto the sample as a line then said line imaged onto the entrance slit of an imaging spectrometer. Thus it is possible to measure a depth profile along said line by a single measurement.

The light from said broadband light source (BQ) is collimated by a lens (L1). The resulting light beam is split by a beam splitter (T) with one part directed into the reference arm to a mirror (S), and the other part into the measurement arm with a cylindrical lens (L2) onto the sample. The sample is thus illuminated along a line.

Light from both arms is reflected back to the beam splitter (T), is superimposed and by using suitable optical Elements (ZL3) is projected into the entrance slit of an imaging spectrometer (ASA). The spectrometer thus records a multitude of spectra (MAS) for points along said line. Commonly used additional apertures and spatial filters are not shown in the drawing.

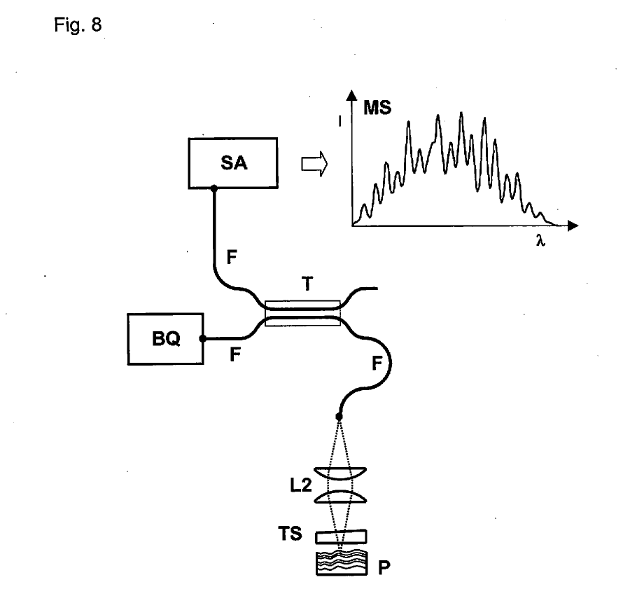

FIG. 8 shows as another example a variation of the interferometric setup as a common path interferometer, i.e. reference path and sample path are partially superimposed.

The arrangement uses a spectrally broadband light source (BQ) and for measuring an optical spectrometer (SA).

In an arrangement according to FIG. 8, the light from said source (BQ) is guided by an optical fiber (F) to a fiber-optical beam splitter (T), with only one output of the splitter actually used. The light is then projected to a suitable optical system (L2) and focussed onto the sample with a partially reflecting mirror (TS) positioned directly in front of the sample.

Light reflected by the mirror (TS) as well as by sample (P) is focussed back into the fibre by said optical system (L2) in and through the beam splitter (T) guided in part into said spectrometer (SA). The spectrometer records a spectrogram (MS), which represents structures of the sample in the manner described.

The otherwise very compact and robust arrangement has the disadvantage that the sample must be located in close proximity or in contact with a surface used as a reference mirror.

All arrangements for OCT based on optical coherence-domain reflectometry have the disadvantage that movable optical elements are required, which modulate the optical path length of the reference arm.

Since these elements are part of the interferometer, a high mechanical precision and appropriate technical efforts are required. Furthermore, the devices have the disadvantage that due to the mechanical movement each measurement requires a certain time, which in biological i.e. moving samples may induce artefacts in the measurement.

In principle, such arrangements only allow a measurement of the intensity of the measured interference signal, the phase information is lost.

Furthermore, because these arrangements have no spectral resolution, they are sensitive to artefacts caused by the spectral dispersion of the path length inside the sample.

Depending on the used type of optical spectrometer the arrangements for spectral OCT based on optical Fourier-domain reflectometry do not need moving parts, but also have the basic disadvantage that spectral measurements generally lack the phase information of the original interferogram.

This hinders the analysis of complex depth profiles and the correction of artefacts, for instance induced by the spectral dispersion of the optical path length within a sample.

The inventive arrangements are characterized by the fact that the phase information of the measured interference signal can be used.

This is done either directly optically at the detector or the measured phase information is provided for a numerical evaluation.

A numerical analysis can use the measured phase information to determine the dispersion inside the sample. Thus, both the spatial resolution can be improved and additional information about the material properties inside the sample can be obtained.

In contrast to OLCT (Optical Low Coherence Tomography) which only uses the interference signal according to the short coherence length of the light source, the new method presented here by utilizing the phase information is able to employ by far more information.

The designation OFCT (Optical Full Coherence Tomography) is proposed for the new method.

The aim of the invention is a method that in contrast to conventional OCT (OCDR) or spectral OCT (S-OCT, FD-OCT) allows for a measurement of additional information about the phase angle of the partial beams brought to interference i.e. the spectrally resolved reconstruction of phase information from the interferogram and thus access to additional information about the spectral dispersion in the interior of the sample.

The aim of the invention further are new arrangement without movable parts appropriate for the new OCT method which takes the phase information into account.

Since the method does not rely on the use of certain types of interferometers, there is a whole series of different arrangements according to the invention that implement the inventive method.

Some particularly advantageous variants are described below.

The combination of the novel method according to the invention and novel arrangements according to the invention and appropriate methods for the numerical analysis of the measurements leads to a novel technique which will be designated as Optical Full Coherence Tomography (OFCT).

This procedure (OFCT) due to the spectrally resolved measurement of the path length in particular allows for the spectrally resolved measurement of the refractive index inside the sample.

This in turn allows not only the appropriate correction of dispersion-induced artefacts.

The spectrally resolved measurement of the refractive index or the spectral dispersion may further give clues about the local chemical composition within the sample.

In particular, this measurement of the spectral dispersion is independent of a loss of intensity caused by scattering and absorption inside the sample.

Some of the new arrangements for OFCT are based on spectrally dispersive interferometers, i.e. interferometers which spectral angular-dispersive optical elements such as diffraction gratings or prisms, and include a spatially resolving detector to record the resulting interferogram.

Using angular dispersive elements in the beam path of the interferometer causes a variation of the path lengths of the beams brought to interference depending on location at the spatially resolving detector. Therefore, a corresponding interferogram immediately can be recorded.

The OFCT technique uses an interferometer with a reference arm or reference path and an measurement arm or measurement path. Measured is a spectrally resolved interferogram such that for an appropriate number of measurement spots, both the intensity of light from the measurement path relative to the light from the reference path and a relative phase angle of the light from the measurement path with respect to the reference path each as a function of the wavelength can be determined.

Claim 1 describes generally the two design options for the method by steps (a) to (f):

(a) First, a spatially coherent but spectrally broadband light source is required. In case the light source does not already create a single spatial mode, such as a laser, the spatial coherence can be achieved employing a spatial filter. It is reasonable to realize parts of the light paths as single-mode optical fibres. By coupling light into a single mode optical fibre, the light is limited to a single spatial mode. Coverage of a broad spectral range can be achieved in different ways: the light source itself may generate a broadband spectrum, such as a super luminescent diode, or a primarily narrowbanded light source is scanned over a spectral range, such as a laser with adjustable wavelength.

In the first case, all wavelengths within a spectral range are emitted simultaneously in the second case successively within a certain time.

The spectrum not necessarily has to be a continuum of wavelengths.

Other variants, such as the superposition of a large number of individual light sources of different wavelengths are also possible.

(b) Generated as a single spatial mode the light is split by a beam splitter into two paths. For both the splitting into the two paths as well as the later superposition of the paths either a split or superposition of the amplitude, for example by using a semitransparent mirror, or a split or superposition of the of the wave front—using a widened beam—is possible.

The use of wave-front splitters may avoid losses.

The two optical paths hereinafter are referred to as the reference path and the sample path.

Usage of integrated optic elements or optical fibres, such as single-mode fibre to split or guide the light may be advantageous.

(c) The sample to be measured is arranged in such a way within the sample path, that light reflected or scattered by the sample is collected.

(d) A distinctive element of the method according to the invention is that for the measurement of intensity and relative phase angle of the light with respect to the reference path several detectors and optionally a plurality of detectors or detector elements are used.

Light from the reference path and the sample path is superimposed onto the detectors or detector elements each with different optical path lengths differences.

The resulting interference signals, thus allow a determination of both the intensity and the relative phase of the light from the sample path relative to the light from the reference path.

In general, at the detectors the light from the reference path shows higher intensity than the light from the sample path. The light from the sample path then by constructive or destructive interference induces a wavelength dependent modulation of the intensity as seen at the individual detectors or detector elements.

In case of a continuously spectrally scanning light source just two detectors or detector elements are sufficient to determine, both intensity and relative phase of the light from the sample path with respect to light from the reference path. Technically more effective are the shown arrangements with four detectors, which allow the determination of a quadrature signal.

It is advantageous to use a detector array with a plurality of detector elements and a systematic variation of path lengths differences for light from the reference arm with respect to light from the sample arm superimposed at each of the individual detector elements.

In this case, the detectors measure an interference pattern which directly indicates the intensity and relative phase of the light from the sample arm with respect to the reference arm.

(e) Recording and analysis of the superimposition of light from the reference arm and light from the sample arm in order to determine path length differences or an OCT signal can be done using an arrangement according to the invention by accumulating the wavelength dependent intensities at the detectors for all wavelengths used while taking into account the relative phase for each wavelength.

Basically two possibilities are available: The intensities either can be measured for all wavelengths separately and the results of the measurements for each detector are added numerically, or the intensities for all wavelengths used can be added optically and the resulting sum of intensities on the respective detectors is measured.

Both options are alternatively described in the main claim:

(e1) Either the intensities for all wavelengths are already optically accumulated on the detectors i.e. summed over all wavelengths used and a measurement data set represents the sum of said intensities measured for each detector. This method is particularly useful when using a plurality of detectors or detector elements of detector arrays and a spectrally broadband light source.

(e2) Or the light intensities at the individual detectors or detector elements can be measured as a function of the wavelength, for each detector followed by a determination of both an intensity and a relative phase of the light from the measurement path with respect to the reference path depending on the wavelength. A Measurement data set is then obtained by numerical accumulation of the measurements for each wavelength taking into account the phase for each wavelength.

While the optical accumulation (e1) of the intensities can be accomplished very quickly and with little effort, the numeric accumulation (e2) of the measurements, has the great advantage that corrections of the phase as a function of wavelength, such as to compensate for spectral dispersion, are possible.

Iterative algorithms for determining said corrections can thus particularly are able to reconstruct a spatially resolved spectral dispersion inside the sample and thus may provide spatially resolved information about the chemical nature of the sample.

(f) A further numerical analysis and visualization of acquired data sets allows to draw conclusions of both spatial position and intensity of the reflection or scattering of the sample or structures inside the sample.

The new method is based on the fact that for the interference resulting from the superposition of light from the reference path and sample path—contrary to device according to the state of the art—a measurement of the relative phase depending on the wavelength can be performed along with the conventional measurement of intensity depending on wavelength. The optical or numerical accumulation of the interference signals of all wavelengths is then carried out taking into account the phase.

The new method can therefore be realized by various new arrangements. Specified The arrangements specified as follows can be divided into different groups:

On the one hand, variants of the arrangement according to variant e1 of step e of the method, which use an optical accumulation of the light intensities at the detectors or detector elements for all wavelengths and then measuring the respective intensities of these accumulation by the respective detectors and detector elements in order to produce a data set,
On the other hand, the variants according to variant e2 of step e of the method which carry out, first a measurement of the light intensities at the detectors or detector elements as a function of wavelength while determining both an intensity and a relative phase of the light obtained from the measurement path with respect to the reference path for each wavelength, and then perform a numerical accumulation of these measurements to obtain a data set.

Arrangements of the two groups according to the invention may each be further divided into a group of arrangements which use broadband light sources and a group of arrangements that use a scanning light source.

And the inventive arrangements can be further subdivided into a group using a few individual detectors and a group using a plurality detectors or in particular a detector array with a plurality of detector elements.

Further variations arise from different types of the underlying interferometric setups.

The splitting of light into a sample path and reference path and the subsequent superposition at the detectors, can be realized in the manner of a Michelson interferometer with a common beam splitter for dividing and superimposing the arms or in the manner of a Mach-Zehnder-interferometer with independent beam splitters for splitting and superimposing the two paths.

The choice of other interferometric arrangements is also possible, in particular, the use of a diffraction grating as a beam splitter is interesting and arrangements of beam splitters which create a division of wave front instead of a division of amplitude.

The inventive arrangements implementing the new method according to the invention differ from conventional arrangements in principle by the fact that several or a plurality of detectors or detector elements of an array detector are used with light from the reference path and sample path brought to interference on each detector with a different path length difference.

Such arrangements of detectors thus allow for the determination of both intensity and relative phase of the light from the sample arm relative to the light from the reference arm.

In case of detectors with a large number of individual detector elements (detector arrays) particularly interesting are arrangements using additional spectrally dispersive elements which for each detector element systematically vary the relative phase of the light from the reference arm with respect to the sample arm depending on the wavelength.

Further possibilities arise in this context by using appropriate amplitude or phase masks, which can facilitate the detection of interference signals.

Further details and advantages of the arrangements according to the invention are illustrated by the various embodiments shown in the drawings:

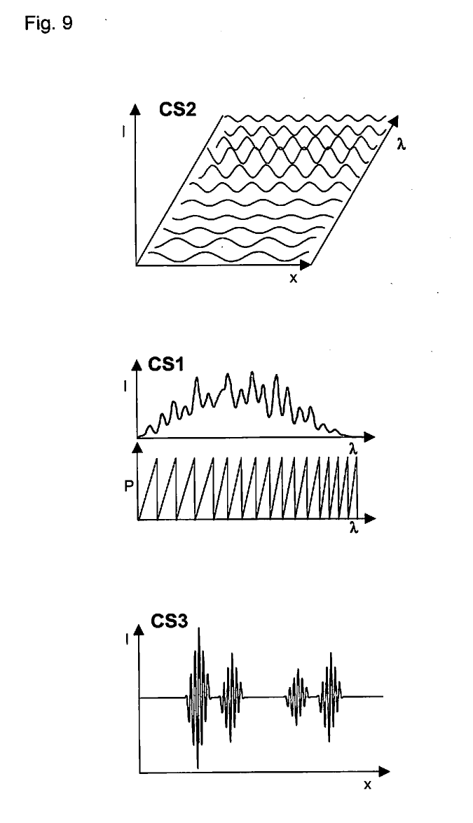

FIG. 9 shows the different variations of the measured signals, which are provided by arrangements according to the invention.

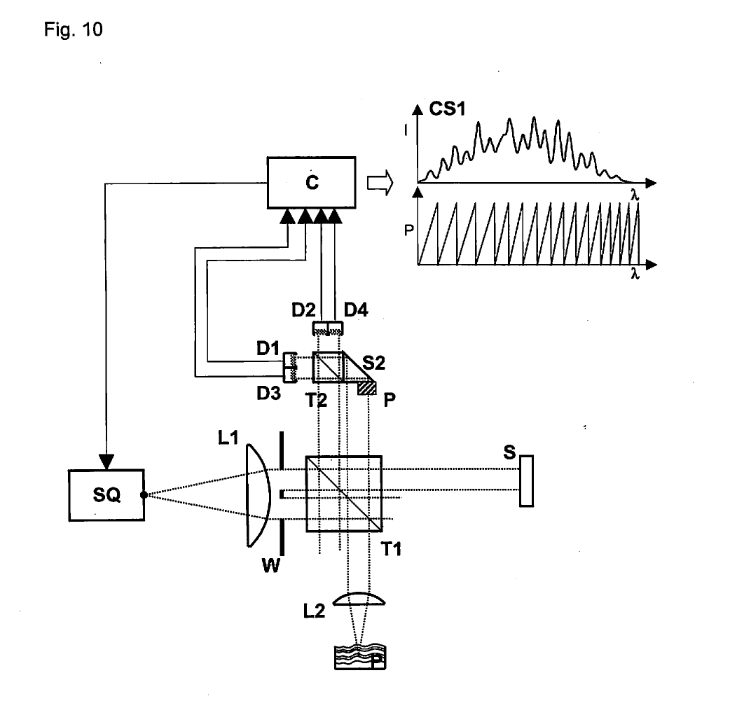

FIG. 10 shows an inventive arrangement with a spectrally scanning monochromatic light source and using multiple detectors for determining the relative phase of the measured signal for each wavelength.

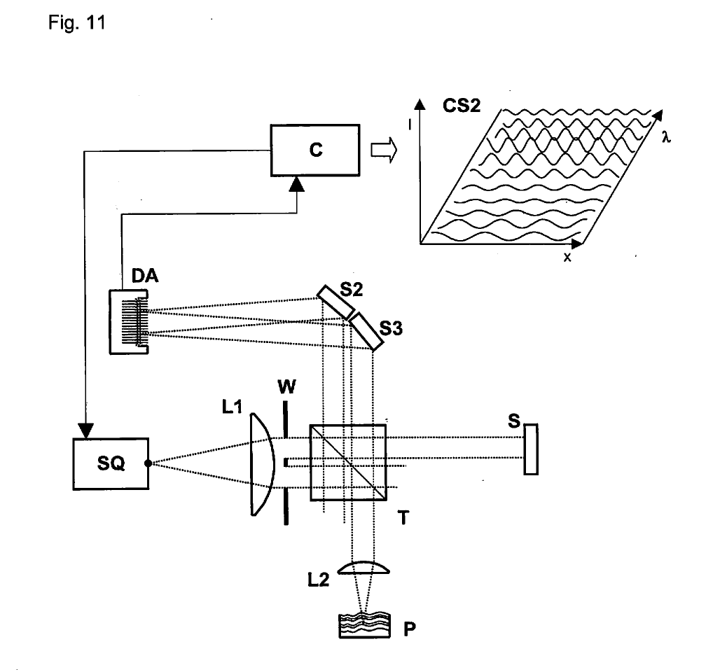

FIG. 11 shows an inventive arrangement with a spectrally scanning monochromatic light source and using a detector array for receiving an interferogram for each wavelengths, which can be used to determine the phase of the signal measured for the respective wavelengths.

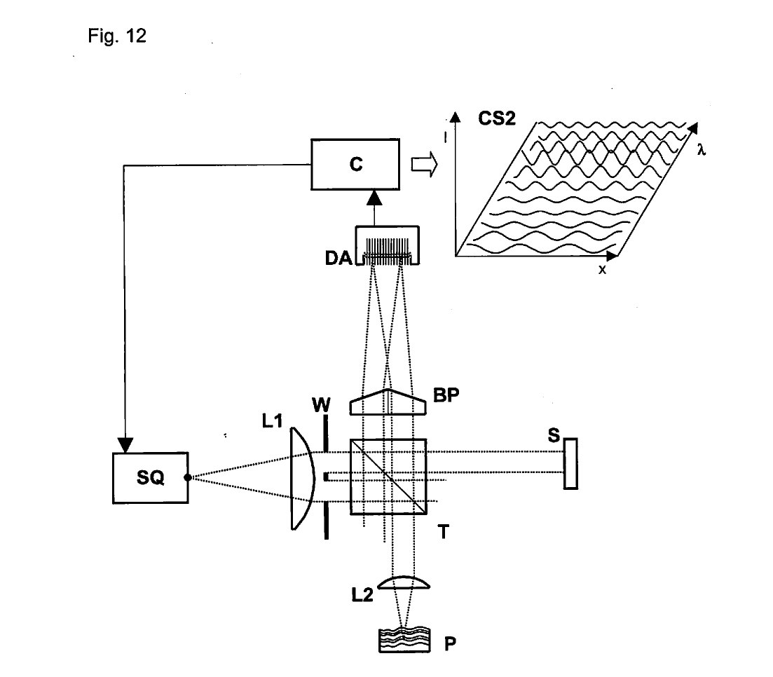

FIG. 12 shows an inventive arrangement similar to FIG. 11 additionally using spectrally dispersive optical elements, which increase the phase variation and thereby improve the resolution.

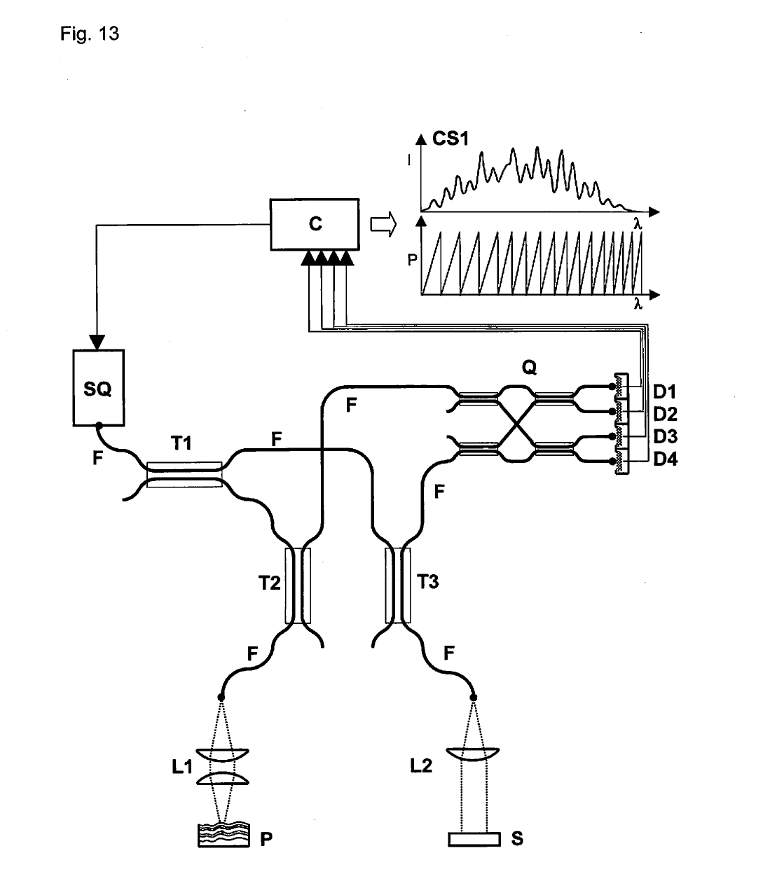

FIG. 13 shows an inventive arrangement with a spectrally scanning monochromatic light source and using multiple detectors for determining the relative phase of the measured signal for each wavelength. The shown use of fibre optic elements or elements of integrated optics, both for guiding the light as well as for interferometric superposition can be technically advantageous.

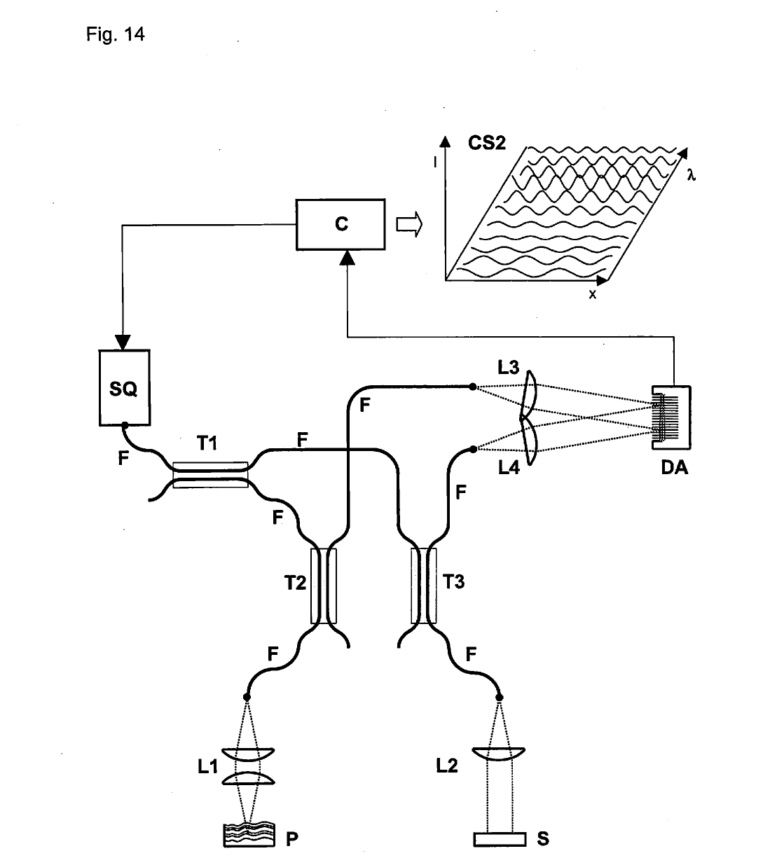

FIG. 14 shows an inventive arrangement with spectral scanning monochromatic light source and using a detector array for receiving an interferogram for each wavelength similar to the one shown in FIG. 11, but with beneficial use of fibre optic elements.

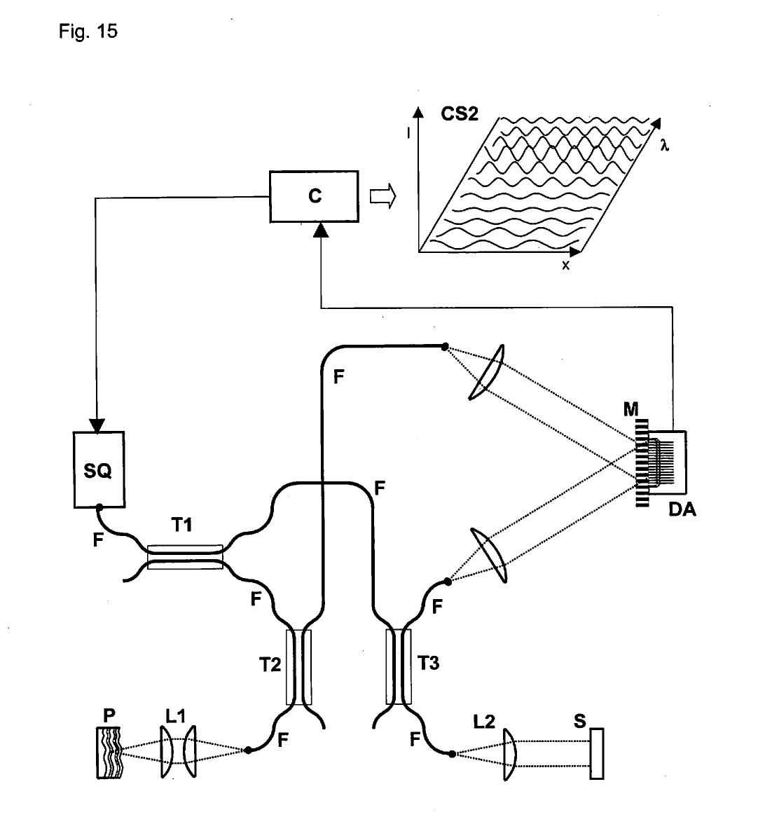

FIG. 15 shows an inventive arrangement similar to the one shown in FIG. 14 but with an additional optical mask mounted in front of the detector, which can be beneficial for the measurement of phase information.

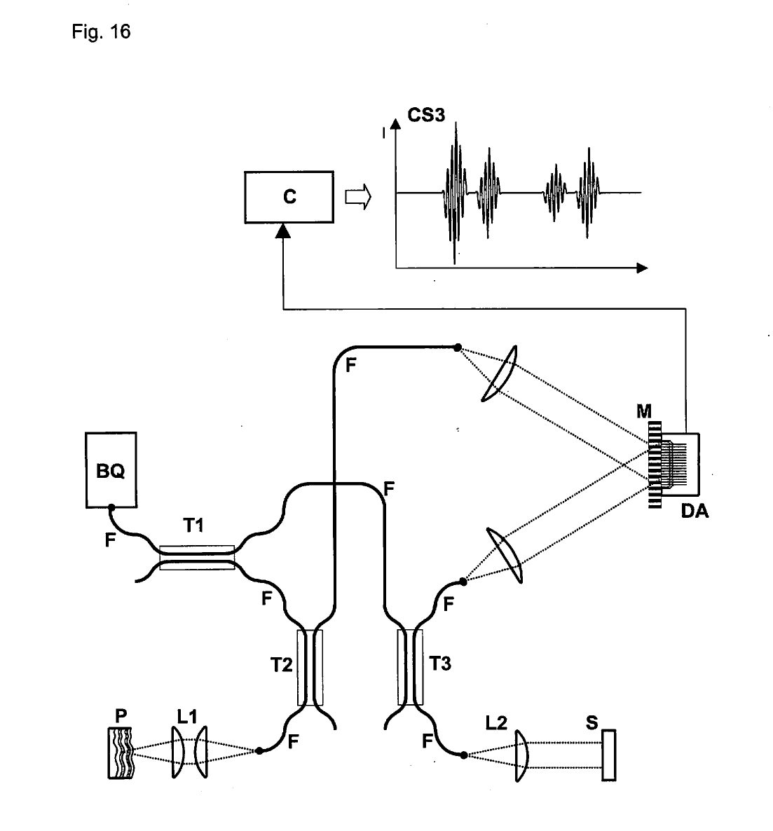

FIG. 16 shows an inventive arrangement which a broadband source (BQ) and also using a optical mask in front of the detector.

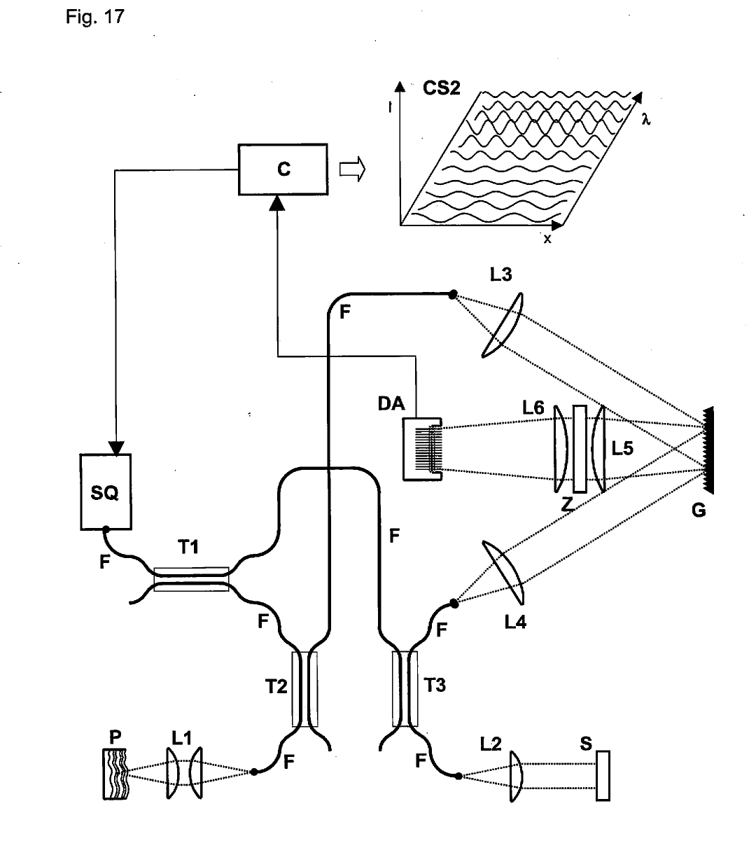

FIG. 17 shows an inventive arrangement with a scanning monochromatic source (SQ) and an array detector. The additional use of a diffraction grating (G) as spectrally dispersive optical element increases the phase variation depending on the wavelength for the recorded interferograms, thereby improving the resolution.

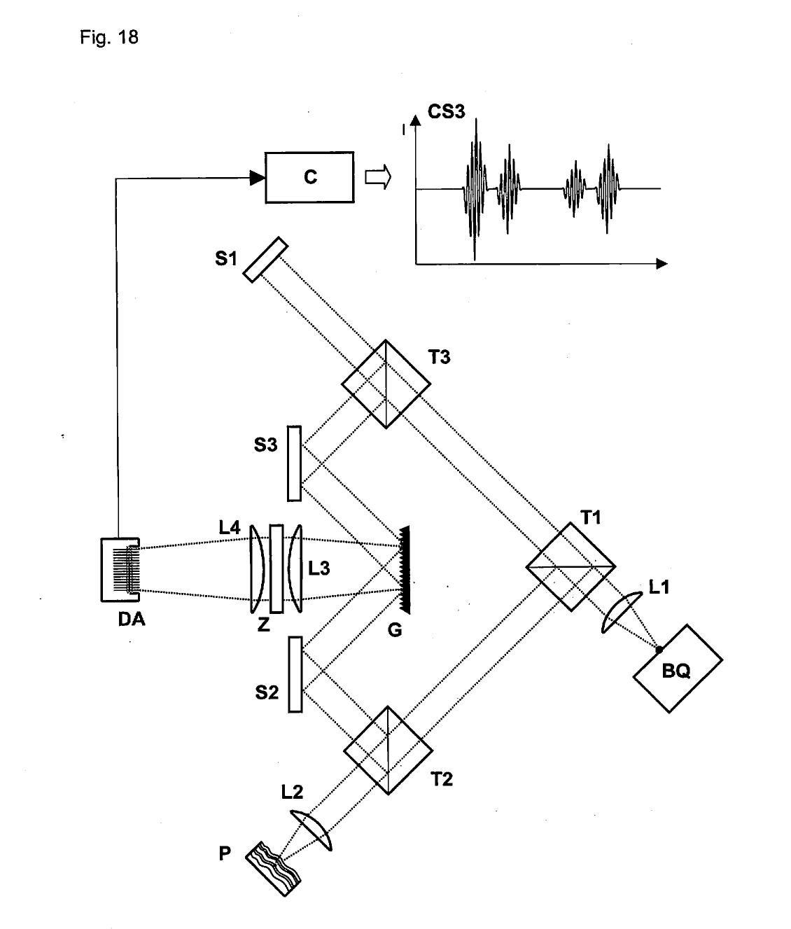

FIG. 18 shows an inventive arrangement which a broadband source (BQ), an array detector, and also using a diffraction grating.

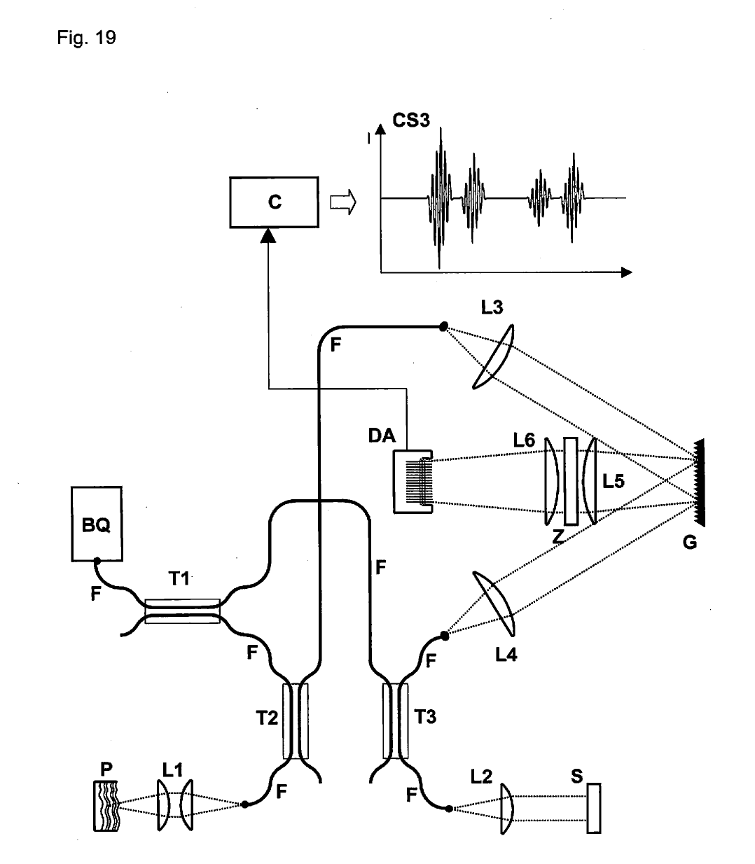

FIG. 19 shows an inventive arrangement similar to FIG. 18, but with advantageous use of fibre optic elements.

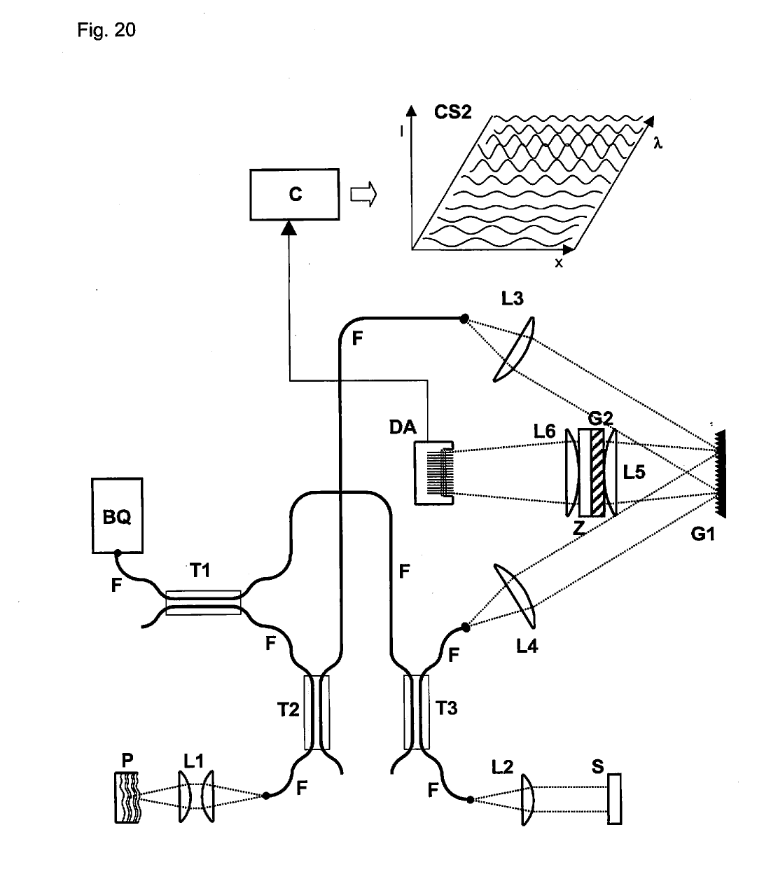

FIG. 20 shows an inventive arrangement with a diffraction grating to increase the phase variation of the interferograms and a broadband source (BQ), however, an additional spectrally dispersive element, (G2) is used that separates the wavelengths on a 2-dimensional detector array.

The listed various types of inventive arrangements and their operation are described in detail below:

FIG. 9, top, (CS2) shows the result of a measurement, as it is produced by inventive arrangements according to FIG. 11, 12, 14, 15, 17 or 20.

The abscissa (x) corresponds to the position of a detector element of a detector array and represents an optical path length difference, the ordinate (I) shows the intensity of the measured signal, the multitude of curves along the extra coordinate (λ) represents the measurements at different wavelengths.

Based on the characteristic sinusoidal modulation of the signals for each wavelength both the intensity of the signal and a relative phase position is determined.

According to step e2 of the main claim, the signals for each wavelength are measured individually followed by a numerical weighted superposition of all signals.

The result of the numeric accumulation is a curve, as shown in FIG. 9. bottom, (CS3). Each burst of modulation of such a curve can be quantified by a Hilbert transformation and corresponding reflections from inside the sample can be assigned.

FIG. 9, middle, (CS1) shows the result of a measurement, as it is produced by inventive arrangements according to FIG. 10 or 13.

The upper curve shows the total intensity of the measured signal (I) as a function of wavelength (λ), the lower curve is the corresponding relative phase angle (P). The abscissa of both curves corresponds to the wavelength (λ), The ordinate in the upper curve (I) represents the measured Intensity. The ordinate of the lower curve is a relative phase angle (P) in the range 0° 360° or 0-2π This curves provide a complex valued signal in polar coordinates as function of the wavelength. The values can be determined for each wavelength from the various detector signals directly or the detector signals are first combined into a quadrature signal in order to determine Intensity and phase.

Based on said measurements a variety of curves as shown in FIG. 9, top, (CS2) can be reconstructed and by accumulation and subsequent Hilbert transformation as described above reflections from inside the sample can be determined.

FIG. 9, bottom, (CS3) shows the result of a measurement, as it is produced by inventive arrangements according to FIG. 16, 18 or 19.

For arrangements according to FIG. 16, 18 or 19, and according to the point el of the main claim the intensity distributions caused by optical interference for the different wavelengths as shown in FIG. 9, top, (CS2) are optically accumulated to form a composite signal (CS3) and then this composition is measured.

The abscissa (x) represents a path length difference, the ordinate (I) the intensity of the signal measured as sum of the interferograms for the different wavelengths for each path length. By using a numerical Hilbert transformation the according reflections from inside the sample can be determined.

FIGS. 10 and 11 show two simple arrangements of the invention, FIG. 1) based on a spectrometer, FIG. 11 based on a scanning light.

In an arrangement according to FIG. 10, the light from a spectrally variable source (SQ) is collimated by a suitable optical element (L1) and passes through a mask (W), which acts as a wave-front splitter splitting the light beam into two spatially separated sub-beams.

Using another common beam splitter (T1) one of the two sub-beams is as the reference arm guided to a mirror (S), the other beam is as measurement arm guided via a focusing lens (L2) onto the sample (P).

The light reflected by the mirror (S) or the sample (P) is projected back to said beam splitter (T1) and directed to a further beam splitter (T2), in the case of the measurement arm via a tilted mirror (S2).

The reference beam is divided spatially again and one part is passing a phase-shifting plate, which delays the optical path length by about ¼ wavelength.

Der genannte zweite Strahlteiler (T2) bringt die dann resultierenden 4 Teilstrahlen an den 4 Detektoren (D1, D2, D3, D4) zur Interferenz.

Said further beam splitter (T2) then creates interference of the resulting 4 sub-beams on the four detectors (D1, D2, D3, D4).

The arrangement has an electronic control and measuring device (C), which controls the light source and records the measured intensities from the detectors while numerically superposing them to a quadrature signal, in such a way that, depending on the wavelength both the intensity and the relative phase of the light with respect to the reference arm (CS1) can be determined.

In an arrangement according to FIG. 11 or 12, the light from a spectrally variable source (SQ) is collimated first by a suitable optical element (L1) and passes through a mask (W), which acts as a wave-front splitter and splits the light beam into two spatially separated sub-beams.

Using another common beam splitter (T1) one of the two sub-beams is as the reference arm guided to a mirror (S), the other beam is as measurement arm guided via a focusing lens (L2) onto the sample (P).

The light reflected by the mirror (S) or the sample (P) is projected back to said beam splitter (T1) and directed either according to FIG. 11 to a pair of mirrors (S2,S3) or according to FIG. 12 to a biprism (BP).

As a result, the light from the measurement arm and the light from the sample arm is superimposed on a detector array which can record the resulting interference signal.

The arrangement has an electronic control and measuring device (C), which controls the light source and records the measured intensities from the detector array such that interference signals are recorded for each of a set of different wave lengths (CS2).

In the case of an arrangement as shown in FIG. 12 the spectral dispersion caused by the biprism (BP) induces an additional phase shift of the signals and increases the depth resolution of the arrangement.

In an arrangement using optical fibers (F) as depicted in FIG. 13, the light from a spectrally variable source (SQ) is first split by a fiber-optical beam splitter (T1) into a measurement path and reference path.

The measurement path leads through a second fibre optical beam splitter (T2) to a projection lens (L1) which focuses the light onto the sample and collects the reflected light from the sample back into the fiber.

Via said second beam splitter (T2), the light is then guided into a fiber optical mixer (Q). The reference path guides the light via a third fibre optic beam splitter (T3) and a collimator (L2) to a mirror (S) which reflects the light back through said collimator into the fibre.

Via said third fibre optic beam splitter (T3), the light is also guided into said fibre optical mixer (Q).

The mixer (Q) is superimposing the light from the two arms at each of the detectors (D1, D2, D3, D4), each with different phase shifts.

The arrangement has an electronic control and measuring device (C), which controls the light source and records the measured intensities from the detectors while numerically superposing them to a quadrature signal, in such a way that, depending on the wavelength both the intensity and the relative phase of the light with respect to the reference arm (CS1) can be determined.

In an arrangement using optical fibers (F) as depicted in FIG. 14, the light from a spectrally variable source (SQ) is first split by a fibre optical beam splitter (T1) into a measurement path and reference path.

The measurement path leads through a second fibre optical beam splitter (T2) to a projection lens (L1) which focuses the light onto the sample and collects the reflected light from the sample back into the fiber.

Via said second fibre optic beam splitter (T2), the light is guided to another collimator (L3). The reference path guides the light via a third fibre optic beam splitter (T3) and a collimator (L2) to a mirror (S) which reflects the light back through said collimator into the fibre.

Via said third fibre optic beam splitter (T3), the light is guided to another collimator (L4).

The light beams produced by said last mentionened two collimators (L3, L4) for the measurement arm and the reference arm are superimposed onto a detector array (DA). Since the beams are superimposed not in parallel, but at a certain angle, there results for each detector element of the detector array a different path length difference inducing different phase shifts for each interference signal.

The arrangement has an electronic control and measuring device (C), which controls the light source and records the measured intensities from the detector array in such a way that the measurement (CS2) allows determination of both the intensity and the relative phase of the light with respect to the reference arm depending on the wavelength.

An inventive arrangement as shown in FIG. 15 works as the described arrangement according to FIG. 14 but with an additional mask (M) positioned in front of the detector array.

The mask represents a striped pattern where the stripes are perpendicular to both optical axes defined by the two beams from the measurement path and reference path.

The mask can be designed as a phase or amplitude mask.

The resulting spatial modulation of intensity at the detector arises then as a beat according to the spatial frequency of the interference pattern and the spatial frequency of the mask.

As these beats show a much lower spatial frequency than the interference pattern itself, the detector requires only a correspondingly lower spatial resolution.

An inventive arrangement as depicted in FIG. 16 operates as the arrangement according to FIG. 15 described above, however a broadband source (BQ) is used.

In this case, the interference patterns for the different wavelengths are not measured separately and the corresponding control of the light source is not needed.

Instead, the respective interference patterns for the different wavelengths are superimposed incoherently onto the detector and the resulting accumulated signal (CS3) is measured.

In an arrangement using optical fibers (F) as depicted in FIG. 17, the light from a spectrally variable source (SQ) is first split by a fibre optical beam splitter (T1) into a measurement path and reference path.

The measurement path leads through a second fibre optical beam splitter (T2) to a projection lens (L1) which focuses the light onto the sample and collects the reflected light from the sample back into the fiber.

Via said second fibre optic beam splitter (T2), the light is guided to another collimator (L3).

The reference path guides the light via a third fibre optic beam splitter (T3) and a collimator (L2) to a mirror (S) which reflects the light back through said collimator into the fibre.

Via said third fibre optic beam splitter (T3), the light is guided to another collimator (L4).

The light beams produced by said last mentionened two collimators (L3, L4) for the measurement arm and the reference arm are superimposed onto a diffraction grating (G) having a similar function as the Mask in an arrangement according to FIGS. 15 or 16. Diffracted beams produced by said grating are imaged to the detector array (DA) by suitable optical elements (L5,L6).

Since the beams are superimposed not in parallel, but at a certain angle, there results for each detector element of the detector array a different path length difference inducing different phase shifts for each interference signal.

The spectral dispersion of the two diffracted beams, i.e. the resulting wavelength dependent variation of the angle at which the sub-beams are brought to interference at the detector generates spatial beats similar to the arrangements according to FIGS. 15 and 16 using said mask (M) and supports the measurement accordingly.

Optionally a cylindrical lens (Z) can focus the resulting interference pattern to a focal line, so that a linear detector array can be used as detector (D).

The arrangement has an electronic control and measuring device (C), which controls the light source and records the measured intensities from the detector array in such a way that the measurement (CS2) allows determination of both the intensity and the relative phase of the light with respect to the reference arm depending on the wavelength.

FIG. 18 depicts a technically advantageous variant of an inventive arrangement. The arrangement uses a broadband light source (BQ). Light from the source is collimated by a suitable optical element (L1) and using a beam splitter (T1) split by amplitude into a measurement path and a reference path.

The light in the reference path is passing another beam splitter (T3) to reach a mirror (S). The light is reflected back to said beam splitter (T3) and is redirected via another mirror (S3) to a diffraction grating (G).

The light in the measurement path is passing another beam splitter (T2) to reach optical elements (L2) focussing the light onto the sample (P). The light reflected by the probe goes back to a mirror (S). The reflected beam goes on to T3 and is redirected via another mirror (S3) also to said diffraction grating (G).

The two mentioned beams from the measurement path and the reference path are superimposed onto the grating (G) in such a way that the resulting two diffracted beams can be imaged to a detector array (DA) by appropriate imaging optical elements (L3, L4)

Since the beams are superimposed not in parallel, but at a certain angle, there results for each detector element of the detector array a different path length difference inducing different phase shifts for each interference signal.

The spectral dispersion of the two diffracted beams, i.e. the resulting wavelength dependent variation of the angle at which the sub-beams are brought to interference at the detector generates spatial beats similar to the arrangements according to FIGS. 15 and 16 using said mask (M) and supports the measurement accordingly.

Optionally a cylindrical lens (Z) can focus the resulting interference pattern to a focal line, so that a linear detector array can be used as detector (D).

The depicted arrangement uses a broadband light source (BQ). Therefore in this case the interference patterns for the different wavelengths are not measured individually and there is no need for controlling the light source accordingly. Instead, the respective interference patterns for the different wavelengths at the detector are superimposed incoherently. Through a suitable control unit (C), the detector array is read out and thus the corresponding accumulated signal (CS3) is measured.

An inventive arrangement as shown in FIG. 19 initially operates like the arrangement according to FIG. 17 as described above but here a broadband source (BQ) is used. In this case the interference patterns for the different wavelengths are not measured individually and there is no need for controlling the light source accordingly.

Instead, the respective interference patterns for the different wavelengths at the detector are superimposed incoherently and the detector array is read out by a suitable control unit (C) thus measuring the corresponding accumulated signal (CS3).

An inventive arrangement as shown in FIG. 20 initially operates like the arrangement according to FIG. 19 as described above using a broadband source (BQ) but uses an additional spectrally dispersive element (G2).

In the illustrated arrangement, said additional spectrally dispersive element (G2) is diffraction grating used in transmission with lines oriented vertically relative to the other diffraction grating (G1).

The detector array (DA) is 2-dimensional in this case.

The spectral dispersion induced by said additional diffraction grating (G2) at the detector separates the interference patterns for different wavelengths.

Therefore, despite the use of said broadband light source, it is possible to measure the respective interference patterns for the different wavelengths at the detector separately.

The detector array is read out using a suitable control unit (C) thus recording the corresponding measurement signal (CS2).

1. A Method for the determination of optical path length differences or for optical coherence tomography comprising the following steps:
(a) generating spatially coherent light from a light source which emits a single spatial mode or with emitted light by appropriate means limited to a single spatial mode, which simultaneously covers a broad spectral range
either by broadband spectral emission,
or by scanning a spectrally narrow banded light source over a wider spectral range,
or by a suitable combination of a variety of light sources of different wavelengths,
(b) splitting at least a portion of the light coming from said light source into two spatially separated paths, a reference path and measuring path by at least one beam splitter and appropriate means for guiding the beam,
(c) placing a sample to be measured in the measuring path such that the light passing through the measuring path is reflected or back scattered by the sample or structures within the sample,
(d) using at least two detectors or a detector with at least two detector elements and means for guiding the beam which superimpose light from the reference path and light from the measuring path onto said detectors or said detector elements producing an interference, such that on the basis of the respective light intensities at the detectors or detector elements, both the intensity and the relative phase of the light from the measuring path with respect to the reference path can be determined,
(e) recording and analyzing the light intensities at the detectors or detector elements according to one of two possibilities as follows:
(e1) initially generating an optical superposition of the light intensities at the detectors or detector elements for all or a portion of all wavelengths provided by the light source available, and then measuring the corresponding intensity of said superposition at the respective detectors or detector elements to obtain a data set, or:
(e2) first measuring the light intensities at the detectors or detector elements as a function of wavelength, with a function of the wavelength determining both an intensity and a relative phase of the light from the measurement path with respect to the reference path for each wavelength, and then performing a numerical superposition of these measurements to obtain a data set, and
(f) numerically analyzing and visualizing said data set such that conclusions can be drawn on both spatial position and intensity of reflection or scattering by the sample or by structures inside the sample.

2. A method according to claim 1 comprising the step of varying the optical path length in the reference arm or the sample arm allowing for the measurement of intensity and phase not only as a function of wavelength but also as a function of different optical path lengths differences.

3. A method according to claim 1, wherein at least one of the reference path or the measuring path comprises at least one additional spectrally dispersive element, such that said spectrally dispersive elements at the location of the detectors cause an additional variation of the relative phase of light from the measuring path with respect to light from the reference path as a function of wavelength.

4. A method according to claim 1, wherein the numerical superposition of the measured interference patterns according to intensity and phase as defined in step (e2) comprises an iterative process, which allows for a spatially resolved determination of the spectral dispersion inside the sample.

5. A method according to claim 1, wherein said spatially resolved determination of the spectral dispersion inside the sample is used to correct a path length measurement or increase accuracy of path length measurements.

6. A method according to claim 1, wherein said spatially resolved determination of the spectral dispersion inside the sample is used to determine material properties of the sample.

7. A device for determination of optical path lengths comprising
a light source which emits a spatial single mode or with the emitted light by appropriate means limited to a single spatial mode, and which covers a broad spectral range either by broadband spectral emission scanning a spectrally narrow banded light source over a wider spectral range or a suitable combination of a variety of light sources of different wavelengths,
a first part of an interferometric setup, with at least one beam splitter, and means for guiding the beam, which splits the light coming from the light source into two spatially separated paths, in the following referred to as the reference path and the measuring path,
means for arranging a sample to be measured in the measuring path such that light of the measurement path is reflected by the sample or scattered by the sample,
a second part of an interferometric setup, comprising
means to direct the beams to superimpose light from the reference path and light from the measuring path creating an interference at a detector or a plurality of detectors, and
said detector or plurality of detectors to record the interference signal structured an arranged or combined with other means in such a way, that both the intensity and a relative phase of the light from the measurement path with respect to the reference path can be determined.

8. A device according to claim 7 wherein an optical detector or the optical detectors are structured and arranged in such a way, that a spatial modulation of the interference signal can be detected and a relative phase of this spatial modulation can be determined, allowing for conclusions about the relative phase of the light from the measuring path with respect to light from the reference path.

9. A device according to claim 7, wherein the detector comprises two or more or a plurality of individual detector elements (detector array) and is structured an arranged such that a spatial modulation of the interference signal can be detected, and a relative phase of this spatial modulation can be determined, allowing for conclusions about the relative phase of the light from the measurement arm with respect to light from the reference arm.

10. A device according to claim 7, additionally comprising means which allow a variation of the optical path length of the reference arm or of the measurement arm.

11. A device according to claim 7 comprising at least one spectrally dispersive optical element as part of the interferometric setup either located within one of the two paths or designed and arranged as a beam splitter of the interferometric setup.

12. A device according to claim 11, wherein said spectrally dispersive optical element or said spectrally dispersive optical elements cause a change in optical path length dependent of the wavelength.

13. A device according to claim 11, wherein said spectrally dispersive optical element or said spectrally dispersive optical elements cause a wavelength dependent change of the angel at which the light beams coming from the two path are brought to interference.

14. A device according to claim 11, wherein the spectrally dispersive optical element or the spectrally dispersive optical elements are constructed as a prism.

15. A device according to claim 11, wherein the spectrally dispersive optical element or the spectrally dispersive optical elements are constructed as diffraction grating.

16. A device according to claim 15, wherein said diffraction grating is used as beam splitter.

17. A device according to claim 15, wherein said diffraction grating is used to superimpose the beams from the measurement arm and from the reference arm.

18. A device according to claim 7, additionally comprising a spatially resolving detector (CCD).

19. (canceled)

20. A device according to claim 8, wherein the detector comprises two or more or a plurality of individual detector elements (detector array) and is structured an arranged such that a spatial modulation of the interference signal can be detected, and a relative phase of this spatial modulation can be determined, allowing for conclusions about the relative phase of the light from the measurement arm with respect to light from the reference arm.

21. A device according to claim 20, additionally comprising means which allow a variation of the optical path length of the reference arm or of the measurement arm.
